(19) United States
(12) Patent Application Publication
(10) Pub. No.: US 2006/0048095 A1
(43) Pub. Date: Mar. 2, 2006

(54) Local type alias inference system and method

(75) Inventors: Henricus Johannes Maria Meijer, Mercer Island, WA (US); Eric A. Gunnerson, Bellevue, WA (US); Peter A. Hallam, Seattle, WA (US); Anders Hejlsberg, Seattle, WA (US); Gary S. Katzenberger, Woodinville, WA (US); Matthew J. Warren, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/930,145

(22) Filed: Aug. 31, 2004

(51) Int. Cl. G06F 9/44

(52) U.S. Cl. 717/114; 717/162

(57) ABSTRACT

The present invention discloses an improved system and method for specifying and compiling computer programs. Type aliases are introduced whose binding is inferred by a type inference component during compilation. Once declared, type aliases can be utilized just like regular types thereby providing added efficiency in coding, among other things. Additionally, a mechanism for specifying the introduction of a new variable whose type is to be inferred is disclosed. This mechanism clears up an ambiguity during type inference concerning whether to infer a new variable type or utilize a variable in scope. Further yet, an efficient type inference system and method is disclosed to effectively deal with overloading among other things.

### TECHNICAL FIELD

The present invention relates generally to computer programming languages and more particularly toward compilers and type inference.

### BACKGROUND

A type system defines the organization of a computer programming language. Among other things, the type system specifies how data types are declared and employed. The process of verifying data types against the type system is referred to as type checking. If the type is checked at compile time, it is referred to as statically typed, whereas a language that is type checked at run time is called dynamically typed. Statically typed languages typically contain variables that can have but one fixed data type. Conventionally, programmers specify types explicitly. For example, int x=47; int y=11; int z=x+y. Here, each of the additive components, x and y, are specified as type integer. Similarly, the result, z, is also expressly denoted as an integer. Thus, if z is specified elsewhere in a local class, method or function as a string type, the compiler would generate an error.

As type systems become increasingly sophisticated, it becomes increasingly cumbersome for programmers to write explicit type declarations on local variable declarations and on invocations of generic methods, for example. Consider the following conventional C# declaration of a generic method MkArray:

```
class Util {
  static public T[ ] MkArray<T>(T first, T second) {
    return new T[ ]{ first, second };
  }
  }
```

To mitigate the burden on programmers and improve succinctness, some conventional languages have employed type inference. Type inference allows programmers to omit type annotations from expressions and/or variables whenever the types can be determined automatically by compilers and/or interpreters from the context. This eliminates unnecessary verbosity thereby making programs more concise and easier to read. For example, in C# it is possible to invoke the MkArray method without explicitly specifying a type argument:

| | |
|---|---|
| int [ ] I = Util.MkArray(5, 213); | // Calls MkArray<int> |
| string[ ] s = Util.MkArray(“foo”, “bar”); | // Calls MkArray<string> |

Through type inference, the type arguments int and string are automatically determined from the arguments to the method by the compiler. Without type inference, a programmer would have been forced to write more garrulous assignments. For example, consider the following:
int[ ] I=Util.MkArray<int>(5, 213);
string[ ] s=Util.MkArray<string>(“foo”, “bar”);

A simple type inference mechanism or methodology proceeds by deriving the types of the arguments of the function. In the first call, for instance, the compiler determines that both 5 and 213 have type int, written as 5<:int, 213<:int. In the second call, the compiler determines that both “foo” and “bar” are strings. Given the actual types of the arguments, the type inference mechanism then continues to match these actual types to the formal type parameters producing a substitution that binds type variables to types. In this scenario, the inferred bindings are T:=int for the first argument and T:=string for the second argument. Given such a substitution, the compiler subsequently verifies that the substitution is complete. That is, it provides a binding for all type generic type parameters, and that it is consistent in the sense that each type parameter is bound to the same type. In the above example, the substitution is both complete and consistent. Given a complete and consistent substitution, the compiler can then insert the correct type-parameters to the generic method invocation. Accordingly, a programmer can simply write:
int[ ] I=Util.MkArray(5, 213);
string[ ] s=Util.MkArray(“foo”, “bar”);

However, it should be appreciated that in the previous example type inference is employed to infer type parameters, but programmers still had to write types for the result or left side of the expression. More complex type inference mechanisms could perform the inference on this side as well. For example, the compiler can determine that T:=int for the first argument and T:=string for the second argument and results in each case are the same. So, based on the type determination from the right side of the argument the type of the left side is able to be resolved. Hence, a programmer need not specify the result type and can write the arguments in the more concise format without any types as follows:
I=Util.MkArray(5, 213);
s=Util.MkArray(“foo”, “bar”);

The actual method of type inference can get much more complicated than the simple examples provided thus far. For example, consider the following variable assignments:
x=“hello”;
x=5;
x=newButton( );
   Here, there are several different assignments to the same variable. The first assignment assigns x the value of “hello” so the type can be inferred to be string. The second assignment assigns x the value of 5 thus the type can be inferred to be string, and finally the third assignment assigns x to newButton( ) so the type can be inferred to be button. Conventional technologies utilize a complex and time consuming procedure called type unification to deal with this type of scenario. Generally, a unification algorithm generates a substitution representing the most general type that will satisfy all the constraints. The substitution must be general enough to allow all the constraints but specific enough to exclude every other type, in other words the least super type of the set. In the above example, conventional systems would infer the type to be object. However, this becomes quite difficult especially with overloading. For instance, if a function takes x and is defined with a myriad of arguments such as int, string, and bool this also provides restraints on x which can be an int, string, or bool. This can get out of hand quickly. Furthermore, even without the added complexity of overloading, unification-based type inference is exponential.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Briefly described, the subject invention concerns systems and methods for inferring types. In particular, the invention identifies several problems with conventional systems and provides novel and efficient solutions thereto.

According to one aspect of the invention, local type components are introduced to alias inferred types. Computer programming can be improved in many ways including but not limited to ease of use and conciseness, if inferred types are available for use. Conventionally, types are inferred by a compiler and stored as an internal type that is unrecognizable and inaccessible to programmers. Accordingly, the subject invention provides for an inference component and methodology that binds the internal type to a type component provided by a programmer. Hence, inferred types can now be utilized as regular types for example to annotate variables or utilize as a type parameter for generic methods, among other things.

Programmers do not always wish to utilize inferred types. Thus, it would be inefficient to generate type aliases constantly regardless of use. Therefore, type components can be omitted when they are not needed. This approaches what is conventionally accomplished. However, there are problems with the conventional technology that have gone unnoticed, particularly with respect to variable declarations. Thus, a new variable indicator is supplied to indicate when a new local variable is being declared, in accordance with another aspect of the subject invention. This indicator, possibly expressed as a keyword, provides clarity in light of much ambiguity. Without such an indicator and in accordance with conventional technologies uncertainty exists as to whether a new local variable is meant to be declared or whether a variable in scope is meant to be utilized. The new variable indicator solves this problem.

According to yet another aspect of the invention, a new more efficient type inference system and method are disclosed that infer and bind types to elements upon initial examination. Conventionally, once an element such as a variable is seen once by a compiler the type is not inferred and bound until the entire program block has been scanned to determine if there are additional declarations of the same variable, and if so a complicated type unification algorithm is employed. The subject system infers and binds the type upon initial examination and generates compile-time errors if the variable is reused in the context of a different type. However, the subject invention also contemplates identifying the errors at compile-time yet delaying errors to run-time.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of a type alias system in accordance with an aspect of the subject invention.

FIG. 2 is a schematic block diagram of a type check system in accordance with an aspect of the subject invention.

FIG. 3 is a schematic block diagram of a type inference system in accordance with an aspect of the subject invention.

FIG. 4 is a schematic block diagram of a type inference system in accordance with an aspect of the subject invention.

FIG. 5 is a flow chart diagram illustrating an inference methodology employing type aliases in accordance with an aspect of the subject invention.

FIG. 6 is a flow chart diagram of an inference methodology in accordance with an aspect of the subject invention.

FIG. 7 is a flow chart diagram of an inference methodology in accordance with an aspect of the subject invention.

FIG. 8 is a schematic block diagram illustrating a suitable operating environment in accordance with an aspect of the invention.

FIG. 9 is a schematic block diagram of a sample-computing environment with which the present invention can interact.

### DETAILED DESCRIPTION

The present invention is now described with reference to the annexed drawings, wherein like numerals refer to like or corresponding elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof to control a computer and implement the subject invention. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

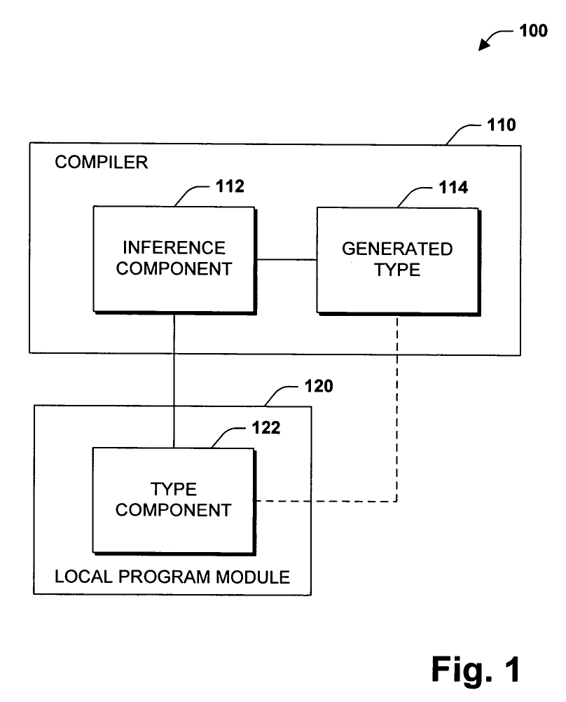

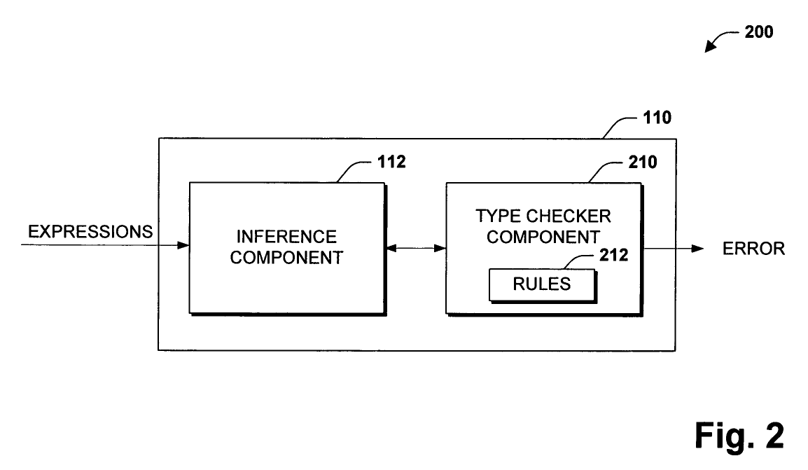

Turning initially to FIG. 1, a type alias system 100 is disclosed in accordance with an aspect of the subject invention. Type alias system includes a compiler 110 and a local program module or block 120. Compiler 110 compiles source code in a source language to target code in a target language. In particular, the compiler 110 enables a user to use high-level computer languages, which are ultimately compiled to machine instructions. Utilization of high-level languages allows users to increase their productivity dramatically as opposed to writing programs in low-level machine or assembly languages. It should be noted that the compiler 110 can also perform optimization techniques to improve run-time execution of the compiled code. One of the major functions of compiler 110 is type checking (described further with reference to FIG. 2). Type checking involves ensuring that a program satisfies the rules set forth by the type system, which define how types are assigned to expressions, among other things. Moreover, type checking involves verifying fully typed programs. However, it is burdensome to require programmers to specify types everywhere they are typically required. Thus, the compiler 110 includes type inference component 112. Type inference allows programmers to omit type annotations that can be deduced from the context. In general, types are often inferred for variables, functions arguments and results. Local type inference, in particular, allows a programmer to elide bothersome and cumbersome explicit type information. For example, consider the following pseudo code:

```
Class C {
  static T duplicate <T> (T t) {return t;}
  static T mkValue<T> ( )where T : new( ) {return new T( );}
}
```

string S1=C.duplicate<string>(“hello”);
string S2=C.mkValue<String>( );
   Here we have one class and two generic methods. The first method is one application of the class. In particular, a static method is called to produce a duplicate string, here “hello.” The second method mkValue is called without any arguments and ultimately creates a default string. It should be noted that both of these methods are fully and explicitly typed. Both the first and second methods take a string and produce a string. However, such explicit typing is not necessary when it can be inferred by inference component or engine 112 from contextual information. Referring to the first method, the inference component can deduce from the declaration that if the argument to the method is of one type then the type parameter is the same. Here, “hello” is a string argument so the type parameter must also be a string. Thus, the type parameter can be omitted and the method can be specified:
String S1=C.dupicate (“hello”);
   However, from the declaration the inference component 112 can also deduce that if the method returns the same type as the argument the result type can by elided and the method can be concisely written as follows without any explicit type declarations:
S1=C.duplicate(“hello”);
   The second method is different. Here, there is no argument that indicates a type for the type parameter. Thus, in this case type inference cannot be employed.

In essence, type inference component 112 generates a type for every expression and sub-expression in a program from context data. As illustrated here, type inference component 112 can interact with a local program module 120 to infer type for expressions defined therein. However, when inference component 112 infers a type it produces an internally generated type 114 that can be used for type checking. The generated type is inaccessible to users and programmers and is stored internally with some obscure compiler generated name. Nevertheless, it would be beneficial if programmers were able to utilize these compiler-generated types. For instance, consider the following pseudo code:

```
Class C {
  Static Collection <T> query<T> (T t) {...}
  Static T mkValue <T>
}
```

Here, rather than returning a type directly like in the previous example there is another generic type, Collection<T>. Consequently, there can be a collection of T, which can be an array, a hash table, and list, among other things. Now assume the following local expression:
Collection S3=C.query(“hello”);
   The expression has been concisely written omitting all types. Accordingly, to type check this expression the compiler 110 employs type inference component 112 to infer the types elided. Thus, it can be determined that the argument is of type string and from the declaration, both collection and query can be determined to be of type string.
Collection<string> S3=C.query<string>(“hello”);
   Thus, the compiler 110 generates a type 114 for T that is of type string. Suppose now that a programmer desired to iterate over the collection and perform some operation. For instance:
For each (s in S3) { . . . s . . . };
   However, a programmer needs to specify the element type of s, but since the type is inferred by the type inference component 112 there is no way of knowing the type. Furthermore, consider the following additional example where a programmer desires to serialize the elements of a constructed array:
i=Util.MkArray(5,213);
s=new XmlSerializer(typeof(???));
   To do this, the element type of the array needs to be passed to the XmlSerializer. So while the programmer was able to omit the type in the declaration of i, because it can be inferred by inference component 112 from the context (e.g., 5 and 213->integers), not much as been gained as a programmer would have to infer the type himself/herself in order to pass it to the constructor.

It should be noted that the present examples have been made simplistic for purposes of clarity. Thus, one could easily look at the provided examples and determine the type. However, the types can be arbitrarily large and complex such as a table of strings of lists of strings and integers, and the like. Therefore, programmers may not even be able to infer the type themselves easily. Moreover, there might not even be a way for programmers to specify the inferred type.

Consequently, one problem with pure type inference is that it is not possible to utilize the inferred type. Typical type inference only allows a variable or generic method type to be inferred. Thus, it is problematic if programmers want another variable of an inferred type, they need to pass the inferred type as a parameter to another generic method, or they need to have the type in hand in any way. In accordance with an aspect of the subject invention, this problem can be solved by introducing a type component 122.

Type component 122 acts as a local type alias. The inference component 112 binds or links an inferred and internally generated type 114 to the type component 122. Once declared, a type component 122 can be employed like a regular type. The type component 122 therefore bridges the worlds of fully explicitly typed languages and fully implicitly typed languages and hence is pivotal in providing expressive power to programmers. In conventional programming languages, which lack this mechanism, programmers are forced to either provide all their types explicitly or provide no type annotations at all.

Type component 122 provides a name for some type, which is bound to by the compiler 110 to a generated type 114 via inference component 112. The type component is specified by a programmer in a local program module or block 122. In order to identify the type component 122, an identifier can be associated therewith. The identifier tells the compiler 110 and more specifically the inference component 112 that a type component is being provided which should be bound to the inferred type of the element (e.g., variable) with which it is associated. Various mechanisms can be utilized as the identifier, such as the “type” keyword.

```
Declaration-statement:
  ...
  local-type alias declaration;
local-type-alias declaration:
    type identifier (, identifier)*
```

Consider the following more concrete example:
type T;
. . .
T[ ] i=Util.MkArray (5, 213);
XmlSerializer S=new XmlSerializer(typeof(T));
   Here, T is declared a type and then the T[ ] is placed adjacent the variable “i.” The type inference component 112 will deduce that the variable is a string and generate an internal type 114. The internal type is then bound to T. As a result, T can be utilized similar to a type variable to provide the type to be serialized.

It should be appreciated that other identifiers and mechanisms can be utilized to introduce the type component to alias local types. One alternative is to introduce the type component by prefixing an identifier to the type component, for example employing a special symbol such as # at one or more defining occurrences. For example:
#r S2=C.duplicate(“hello”);
   Here, the type inference component will produce a generated type 114 that identifies the type of C.duplicate and S2 as string based on the argument being declared a string. Subsequently the inference component will bind the generated type 114 to the type component “r.”

The type component can be utilized outside of the variable declaration context. For instance, the type component can be utilized as a type parameter or constructed type to name but a few examples. Case in point:
Collection<#t> S3=C.query (“hello”);
   In this example, the inference component 112 will deduce from the argument “hello” that C.query is of type string. From there, it will be determined that the collection type parameter is of type string and the type component t will be bound to type string. Subsequently, the type component can be utilized as a regular type to define types. For instance: t y=“Bye”. Here, the variable y is defined as being of type t, which is bound to string, so y is of type string.

The type component 122 is beneficial in many ways; however, it is particularly useful when dealing with complex data types. As described above, inferred types can be quite complex such that it may not be easy or practically possible for programmers to infer and/or specify such types themselves. One area in which types become quite complex is queries. For instance:
X=Select Name, Age from Customer.orders

From this, we know that this expression returns some collection of values that have a name and an age. For example, name can be of type string while age can be an integer. There are at least two problems associated with this example. First, one can appreciate how fast this type can become unmanageable. For example, the type could include name, age, date of birth, country, address, zip code, phone number, email, etc. The second problem, which is even worse, is that programmers may not even have a way to write such a type. Therefore, the result type is a collection of something, collection <T>, and it is known that the type T is defined as:

```
class T {
  string Name;
  int Age;
}
```

However, the actual type T is not known. In fact, during type inference this is a compiler-generated type 114, which is hidden from and inaccessible to programmers. In essence, the type inference component 112 will generate some type T, but the name of such type is not exposed and even if it were, it would be in an incomprehensible compiler format (e.g., T1034F6V). However, with the subject system 100 this is no longer a problem as the type component 122 can alias the compiler-generated type in friendly terms. For instance, the result can be written collection <#Q>. Now, a programmer can simply refer to the given type parameter “Q” rather than the hidden obscure generated type 114. Then, the type can be easily employed, for example:

```
for each (Q s in S3){
  s.name;
  s.age;
}
```

It should be noted and appreciated that the compiler 110 utilizes the inference component 112 to infer types and bind them to type components 122. The scope of the type component 122 that aliases an inferred type is local. The type component 122 resides in a local program module or block 120. The scope of the type component 122 can therefore be limited to that block or module similar to the scope of a local constant or variable declaration. Of course, it is possible to have different scoping rules for type component aliases than for local variable or local constant declarations.

FIG. 2 illustrates a type check system 200 in accordance with an aspect of the invention. Type check system 200 includes a compiler 110 with an inference component 112 and a type check component 210. In general, inference component 112 receives programmatic expressions and infers any omitted type annotations from the local context. Type checker component 210 receives a fully typed expression from the type inference component and checks the expression against type rules 212 to determine if the expression satisfies the rules. The rules 212 ensure, inter alia, that the set of all bindings for local type component aliases 122 (FIG. 1) are both complete and consistent. If the expression fails to satisfy any of the rules 212 the type check component 210 produces an error (e.g., compile time or run time).

Local type alias components can be bound wherever types are inferred. Consider, for instance, the following local variable declarations:

| | |
|---|---|
| type T; | |
| T x = 47; | //inferred T := int |
| T y = 11; | //inferred T := int |
| T z = x + Y * 2 | //inferred T := int |

In this first example, the type component alias T is consistently bound to integer so the type check component 210 would not generate an error.

| | |
|---|---|
| void f<R> (R[ ] rs { | |
| type T, S; | |
| T x = rs [0]; | //inferred T := R |
| S y = rs [1]; | //inferred S := R |
| x = y; | //inferred S=T=R |
| } | |

As per this second example, type aliases S and T are both bound to R and hence S=T are equal and simply another alias for R.

| | |
|---|---|
| type T; | |
| T x = 47; | //inferred T := int |
| T y = true | //inferred T := bool |

In the above example, the type alias T is inconsistently bound to both int and bool and hence this would lead to compile-time error generated by the type checker component 210.

Conventional type aliasing rules imply it is not possible to bind type aliases, for example, in the context of inferring type parameters of a generic method. It should be noted, however, that it is in fact possible to devise alternative rules that would allow local type aliases to be bound even in the context of generic method type parameters. According to an aspect of the subject invention, inference rules 212 are provided for binding type component aliases to types or leaving them unbound. Furthermore, at the expense of added complexity, more liberal rules can be utilized to allow type aliases to be bound to other type aliases as well as for allowing constructed types to include type aliases. An exemplary set of rules 212 are provided hereinafter.

The rules 212 for inferring the type of a local variable declaration P x=e follow the same rules 212 as type inference for generic method invocations, but again, another set of rules 212 can be employed to compute a set of bindings for local type aliases from a declared type and a derived type. Assume that the local variable expression e the type A where all type aliases Tx that appear in A have been replaced by their bound type Sx given the currently computed set of substitutions Tx:=Sx, and that the declared type of variable x is type P. Type inference can operate on the types A and P according to the following steps and produces a set of new bindings Tx:=Sx, where Tx is a type alias and Sx is a type that does not contain any type aliases. Nothing is inferred from the initializer expression e, but type inference succeeds with the empty binding set if any of the following are true: (1) P does not involve any local type alias, or P is equal to A; (2) the initializer expression e is the null literal; (3) the initializer expression e is an anonymous method; and (4) the initializer expression e is a method group. Furthermore, if P is a local type alias, and A does not contain any local type aliases, the type inference succeeds for this declaration with the substitution P:=A. If P is an array type and A is an array type of the same rank, then replace A and P respectively with the element types of A and P and repeat the step. If P is a constructed type, and A does not contain any local type aliases, and if, for each local type alias Tx that occurs in P, exactly one type Sx can be determined such that replacing each Tx with each Sx produces a type to which A is convertible by standard implicit conversion, then inferencing succeeds for this local variable declaration with the substitution set Tx:=Sx. Otherwise, the type inference fails.

If the local variable declaration in a block is passes through the above rules 212 with success, then all inferences that were produced from the previous local variable declaration can be pooled. This pooled set of inferences must then have the following properties. If the type alias occurred more than once, then all of the inferences for that type alias must bind to the same type. In short, the set of inferences must be consistent. At any given point in the block where the type bound to a local type alias is needed (e.g., for overloading resolution, in the derived type of a variable initializer, . . . ) the type alias should have been bound. This ensures that an unbound alias is never bound to another alias. The example below is alright because the type alias T is bound at the point overloading resolution is applied in the Console.WriteLine statement:

void F( ) {

| type T; | |
|---|---|
| T temp = default (T); | //T remains unbound |

while (true) {

| | |
|---|---|
| T[ ] ts = Util.MkArray(47, 11); | //T := int |

foreach (T t in ts {

. . .temp = t; . . .
Console.WriteLine (temp);
. . .

}

}

}

The following example leads to a compile-time error since type alias T would be bound to another type alias S instead of a type:
type S, T;
S s=default (S);
T t=s; //T:=S not allowed

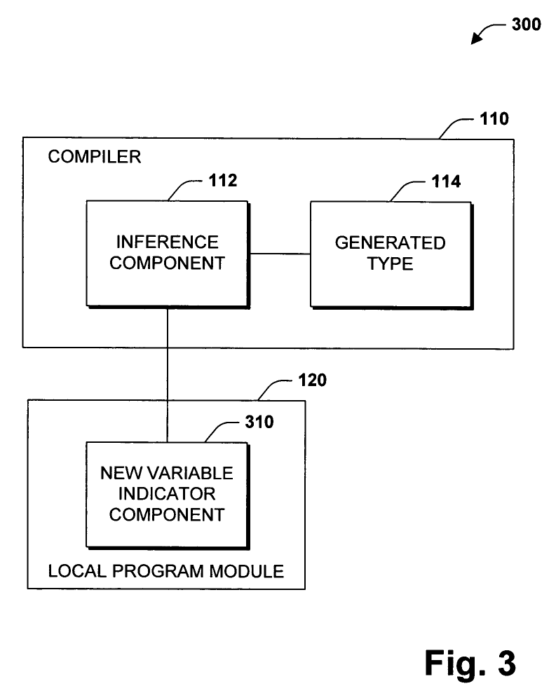

There may be times, however, where type component aliases are not needed because the type is not going to be used again. In other words, a programmer wants to utilize type inference on an expression, but they are never going to employ the inferred type, for example, as a type parameter. Turning to FIG. 3, a type inference system 300 is depicted in accordance with an aspect of the invention. Similar to system 100, system 300 includes a compiler 110 including a type inference component 112 and a generated type 114, as well as a local program block or module 120. However, system 300 now includes a new variable indicator component rather than a type alias. Inference component 112 is utilized to infer local types associated with expressions (e.g., variable declarations . . . ) in a program including a plurality of local program modules 120. Among other things, the local program module 120 can have one or more new variable indicator components 310 associated with variable declarations. The new variable indicator component 310 informs the inference component 112 that it is a new variable and that it can infer the variable's type based on local context. Upon receipt of this indicator, the type inference component produces a generated type 114 of the inferred type.

To truly understand and appreciate the subject system 300, it is necessary to understand one of the problems solved by it. Consider the following pseudo code for example:

class X {

int S1

void F( ) {
. . .
S1 = expression
. . .

}

}

Here, there is a class x with a local variable S1 defined as type integer. Within the scope of this variable, in F( ), variable S1 is again employed and assigned to some expression. Accordingly, ambiguity arises concerning whether a programmer meant to introduce a new local variable or whether he/she meant to assign to the local variable previously declared. Therefore, the compiler 110 does not know whether to infer a new type. If the type were given, for example, Bool S1=expression then the compiler will recognize that this is a new local variable, however this is how it is done without type inference. Hence, just leaving out the type is not is not good enough in the case of type inference, because the inference component 112 cannot distinguish between creating a new local variable and assigning to something in scope. Accordingly, the subject invention provides for a new variable indicator component 310 associated with a variable in a variable expression of a local program module 120. In accordance with an aspect of the invention, the new variable indicator component 310 can include a keyword including but not limited to var, let, or dim. For example:

class X {

int S1

void F( ) {
. . .
var S1 = expression
. . .

}

}

Here, the new variable indicator component 310 represented as the keyword Var in the above pseudo code informs the compiler 110 that the S1 in the function F( ) is a new variable distinct from the other variable S1 in scope. In accordance therewith, the inference component 112 can infer the type from the local context, namely expression.

To summarize what as been presented thus far, in system 100 of FIG. 1 a type component alias is generated to provide a name for the compiler generated type such that it can be exposed to and employed by a programmer. In system 300 of FIG. 3, the compiler is notified by the new variable indicator component 310 to generate its own name, the compiler generated type 114, and hide it because the programmer s not going to utilize it any further. Therefore, traditionally in conventional explicitly typed languages a programmer would have to write something like int x=5, where the type of the variable x is explicitly specified as an integer. Alternatively, a programmer could simply say #t x=5. Now, the programmer does not have to think about what type x is, rather they tell the compiler to infer the type and bind it to t. However, suppose the programmer never uses this type t anywhere. Then, it is wasteful to have the compiler come up with a type and bind it to t. Instead, a programmer can simply say var x=5. Now, the compiler is informed that this is a new variable and that it can infer the type of x and come up with its own internally generated name for such type.

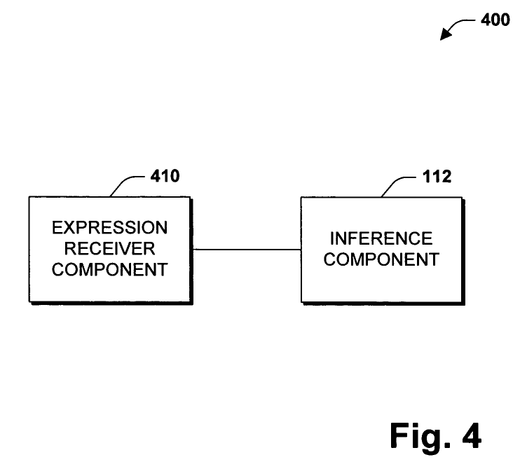

FIG. 4 depicts a type inference system 400 in accordance with an aspect of the subject invention. System 400 includes an expression receiver component 410 and an inference component 110. Expression receiver component 410 receives expressions (e.g., variable declarations) from a computer program. The expressions are then transferred to type inference component 110, which infers data types associated with elements of expressions based on at least a portion of the expression. For instance, consider the expression var x=5. Here, the type inference component 112 infers type integer associated with the variable element x based on the integer argument five.

Conventional technology infers types in a complicated and inefficient manner. In particular, the technology infers the most general type of a plurality of assignments. By way of example, assume that the following variable assignments:
var x=“hello”
   x=5;
   x=newButton( );
      In this example, there is a plurality of assignments associated with a single variable. Accordingly, three different types can be inferred for the single variable x, namely string, integer, and button. Conventionally, it is said that x must have all of these types. Hence, the most general type that will satisfy all these constraints will be inferred. Conventional technologies utilize a procedure called type unification to deal with this type of scenario. Generally, a unification algorithm generates a substitution representing the most general type that will satisfy all the constraints. The substitution must be general enough to allow all the constraints but specific enough to exclude every other type, in other words the least super type of the set. In the above example, conventional systems would infer the type to be object. However, this becomes quite difficult and complex especially with overloading. For instance, if a function takes x and is defined with a myriad of arguments such as int, string, and bool this provides restraints on x which can be an int, string, or bool. These restraints can get out of hand quickly. Furthermore, it should be appreciated that even without the added complexity of overloading conventional unification-based type inference becomes exponential.

The subject invention addresses this problem by binding the first element to an inferred type. If the inference component 112 encounters the same element it should be bound to the same type or the component 112 will generate a compiler-time error. This is a more efficient approach than is conventionally known and does not blow up in terms of inference time. It should be noted that the conventional inference technology can break down to a scenario that superficially resembles the subject invention. For example, if there is one a single variable declaration in a local programming block such as x=“hello.” Here, conventional technology will not immediately infer and bind string type to x as the subject invention, but rather would scan the entire local code section to determine if there are additional instances of the variable x such that a super type can be calculated. After not locating a variable x with a different type, the conventional technology would only then infer and bind string type to x. The subject invention would infer and bind the type to x as soon as it is encountered and return an error if later it is found that the same variable is to be bound to a different type. In essence, the in system 400 is much more efficient. Furthermore, it should be appreciated that conventional languages that employ type inferences up to the time of this invention do not employ subtypes but rather utilize a lengthy and time-consuming unification calculation to determine the most general type.

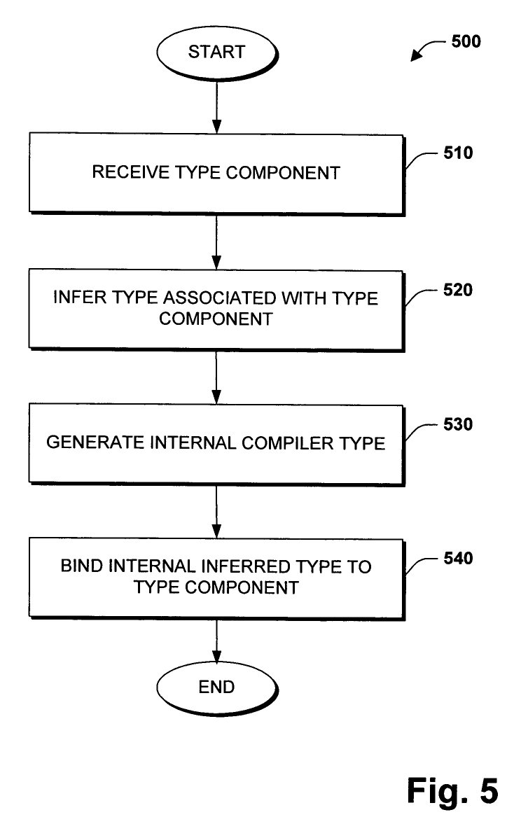

In view of the exemplary systems described supra, a methodology that may be implemented in accordance with the present invention will be better appreciated with reference to the flow charts of FIGS. 5-7. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Turning to FIG. 5, a type inference methodology 500 is depicted in accordance with an aspect of the invention. At 510, a type component is received from a local program block. The type component is associated with some programmatic expression or statement such as a variable declaration or a generic type. The type component can include a type variable name that is adapted to store the type of the element with which the type component is associated. The type component can be identified in a program by one or more identifiers. For example, a unique symbol or expression can precede or follow the type component such as # or [ ] (e.g., # T or T[ ]). At 520, a type is inferred for an element associated with the type component. For example, in the expression #T x=“hello,” the type for x is inferred to be string based on the context, here the string argument “hello.” Subsequently or concurrently therewith, the compiler generates an inaccessible internal type corresponding to the inferred type, at 530. At 540, the internal type is bound or linked to the type component. Hence, the type component is a type alias to the generated inferred type. Accordingly, the type component can be utilized as a regular type to define the types of such things as variables and generic types.

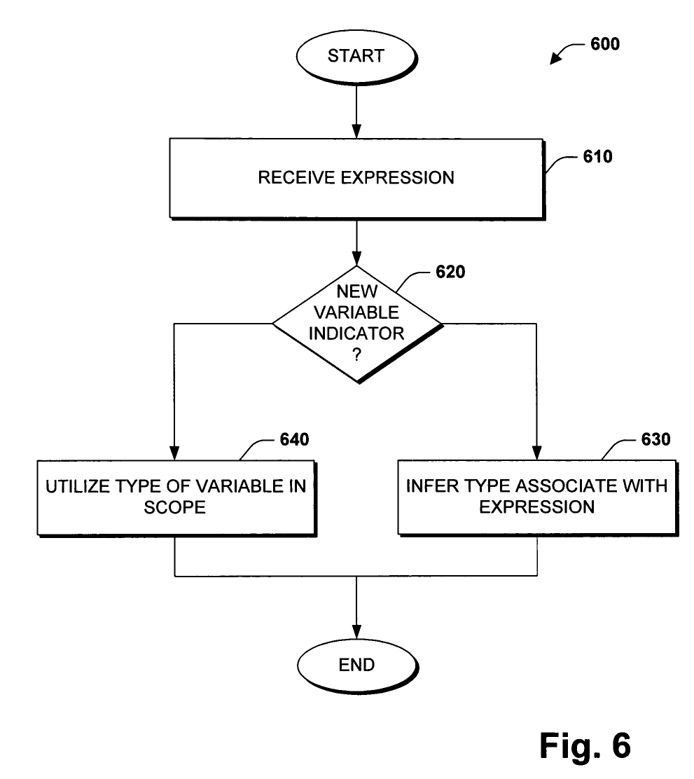

Turning to FIG. 6 another type inference methodology 600 is illustrated in accordance with an aspect of the subject invention. Methodology 600 determines how inferences, if any, will be made on variables in a local program module. At 610, an expression is received. The expression can include a variable and a sub-expression or statement, for example to declare a variable. At 620, a determination is made as to whether the variable in the expression has an associated new variable indicator. The new variable indicator denotes the fact that a new local variable is being defined. The new variable indicator can be in the form of a symbol, phrase, or keyword, among other things. For instance, the new variable indicator can include but is not limited to var, dim and let. Accordingly, a sample expression could be var x=5. If there is a new variable indicator associated with a variable then the type thereof should be inferred from the expression at 630. If, however, there no new variable indicator associated with the variable then inference is not performed on the expression and a type associated with another variable in scope can be provided as the variable type. Employment of the variable indicator provides a mechanism for notifying the type inference component whether to infer the type from local context or utilize the type of an identically named variable in scope thereby removing any ambiguity and providing correct typing.

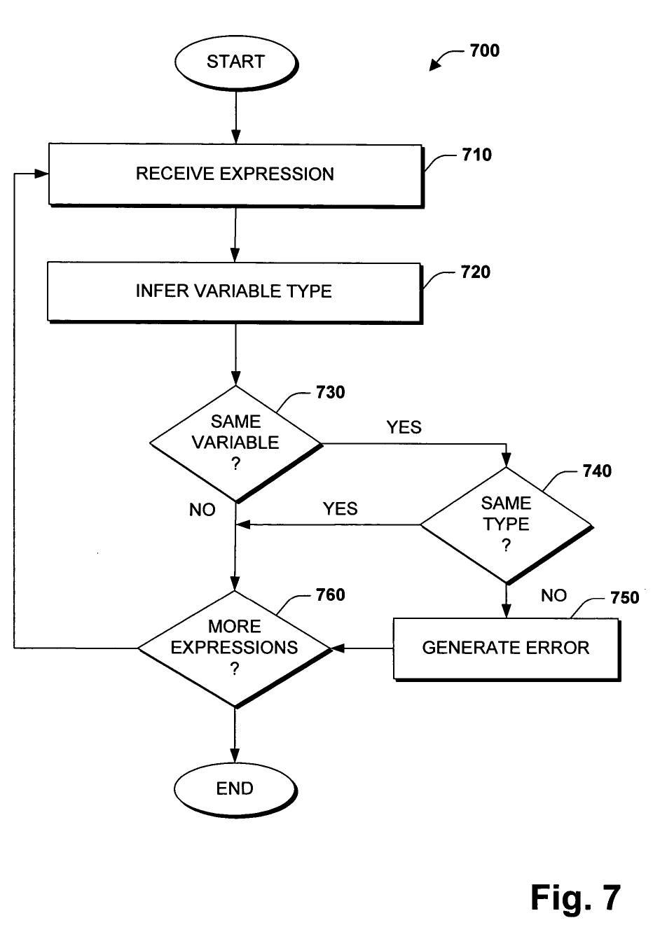

FIG. 7 is a flow chart diagram illustrating a type inference methodology 700 in accordance with an aspect of the subject invention. At 710, an expression is received from a program. For example, the expression can correspond to a variable declaration such as var x=5. At 720, the type of a variable or element is inferred based on the context of the expression. Here, the type of x is inferred to be integer based on the argument being an integer five. At 730, a determination is made as to whether the same variable or element as been seen before by the type inference component. If yes, then a second determination is made as to the type of the variable at 740. If the variable is of a different type than the previously calculated type, then the method proceeds to 750 where an error is generated. Thereafter, the process can continue at 760. If at 740, the variables have the same type, the method proceeds at 760. Furthermore, if the variable under examination is a different variable then the method proceed continues at 760. At 760, a determination is made as to whether there are any other expressions to examine. If yes, the method continues at 710, where another expression is received or retrieved. If no, the method 700 terminates.

Throughout this detailed description, generation of errors has been described specifically in the context of compile-time errors. It is often advantageous to locate errors at compile time so that such errors can be remedied early in the developmental process. It should be appreciated, however, that the subject invention also contemplates generating run-time errors even though the system could identify them at compile time. In essence, detected compile-time errors can be delayed until run time. To enable such functionality, a flag can be set, for example, in the type checker component to specify when such errors are to be delayed. This provides additional flexibility with respect to when such errors are to be addressed.

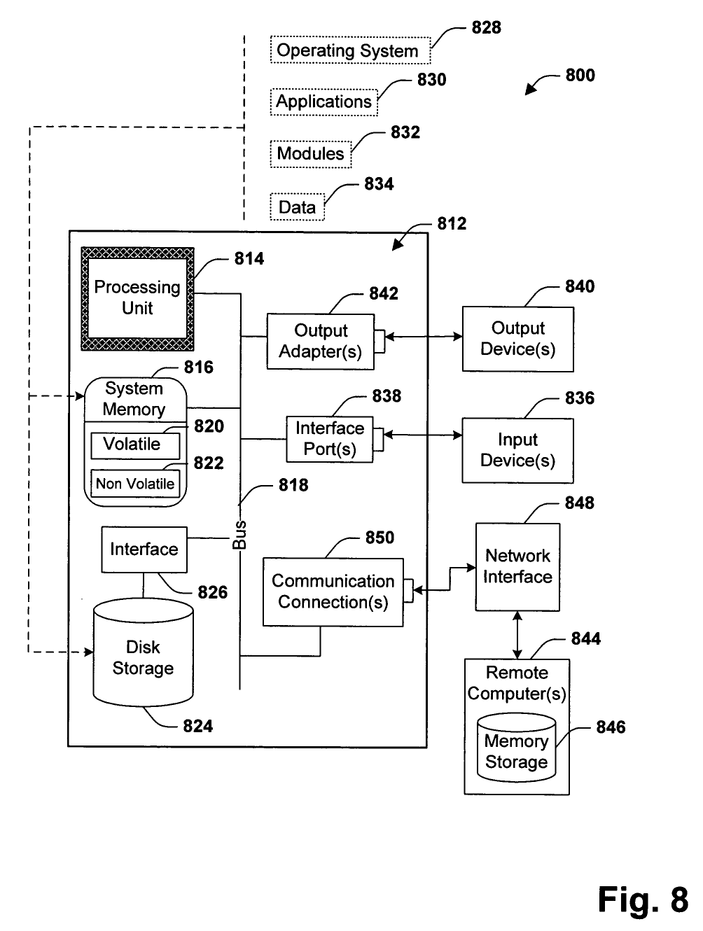

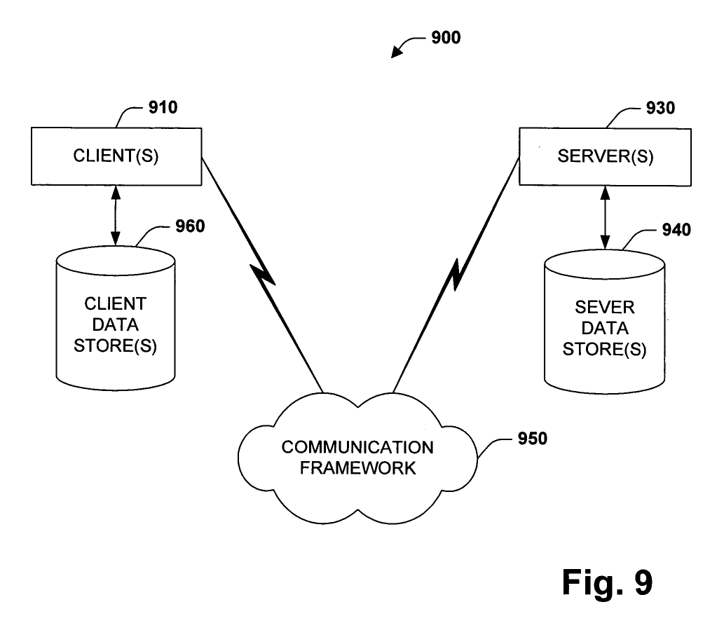

In order to provide a context for the various aspects of the invention, FIGS. 8 and 9 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example disk storage 824. Disk storage 4124 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like displays (e.g., flat panel and CRT), speakers, and printers, among other output devices 840, that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems, power modems and DSL modems, ISDN adapters, and Ethernet cards.

FIG. 9 is a schematic block diagram of a sample-computing environment 900 with which the present invention can interact. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the present invention, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An implicit type system comprising:
a type component that aliases types; and
an inference component that infers a type based on local context and binds that type to the type component.

2. The system of claim 1, wherein the type component is declared by a programmer.

3. The system of claim 2, wherein the type component is specified with an indicator followed by a type variable, the indicator informs the inference component to bind the type to the specific type variable.

4. The system of claim 3, wherein the indicator is a hash mark (#).

5. The system of claim 2, wherein the type component is specified as a type followed by a type variable.

6. The system of claim 1, wherein the type component provides access to an internal compiler generated type.

7. The system of claim 1, wherein the inference component receives an expression including an assignment portion and a result portion and the inference component infers the type of the result portion based on the assignment portion.

8. The system of claim 1, wherein the type component replaces an explicit type declaration.

9. The system of claim 8, wherein the type component is a type parameter.

10. The system of claim 8, wherein a constructed type includes the type component.

11. The system of claim 1, wherein the type component scope is limited to a block in which the type component is declared.

12. The system of claim 1, wherein the type component is bound to another type component.

13. A computer readable medium having stored thereon the computer executable components of claim 1.

14. A type alias system comprising:
a type component to alias a type;
an inference component that receives an expression, infers a type based on at least a portion of the expression, and links the inferred type to the type component, wherein the type component enables access to and use of an internal compiler generated type.

15. The system of claim 14, wherein the type component replaces an explicit type declaration.

16. The system of claim 14, wherein the type component is specified with an indicator followed by a type variable, the indicator informs the inference component to bind the type to the specific type variable.

17. A type inference system comprising:
a new variable indicator component associated with a variable declaration; and
a type inference component that produces a generated type that provides a data type associated with a variable based at least on a portion of the variable declaration.

18. The system of claim 17, wherein the new variable indicator component provides notice to the inference component that an associated variable is a new local variable rather than variable in scope and that the type of the variable should be inferred by the inference component.

19. The system of claim 17, wherein the variable declaration is in the form variable=expression.

20. The system of claim 19, wherein the new variable indicator component is associated with the declaration in the form indicator component variable=expression.

21. The system of claim 19, where the new variable indicator component is expressed as a symbol or keyword.

22. The system of claim 21, wherein the keyword is one of var, dim and let.

23. A computer readable medium having stored thereon the computer executable components of claim 17.

24. A type inference system comprising:
an expression receiver component to receive expressions from a computer program; and
an inference component that infers data types associated with elements of an expression and generates an error if the inference component infers a different type for the same element.

25. The system of claim 24, the error is one of a compile-time error and a run-time error.

26. A computer readable medium having stored thereon the computer executable components of claim 24.

27. A type inference methodology comprising:
receiving a type component associated with an element from a computer program;
inferring a data type associated with the element; and
linking the inferred type to the type component.

28. The method of claim 27, further comprising generating an internal compiler type that is inaccessible to programmers.

29. The method of claim 28, further comprising linking the type component to the internal compiler type, the type component acting as a type alias.

30. The method of claim 29, wherein the type component is specified in a program with a name and identifying symbol or keyword preceding or following the type component name.

31. The method of claim 30, wherein the identifying symbol is #.

32. The method of claim 27, wherein the linked type component defines a variable type.

33. The method of claim 27, wherein the linked type component defines the type associated with a generic type.

34. A computer readable medium having stored thereon computer executable instructions for carrying out the method of claim 27.

35. A method for type inference comprising:
receiving an expression defining a variable;
inferring the type of the variable from at least a portion of the expression if a new variable indicator is associated with the variable.

36. The method of claim 35, further comprising determining the variable type from a variable in scope in the absence of a new variable indicator.

37. The method of claim 35, wherein the variable indicator includes a symbol, phrase or combination thereof.

38. The method of claim 37, wherein the phase is one of var, dim, and let.

39. The method of claim 35, further comprising generating an internal compiler type associated with the inferred variable type.

40. A computer readable medium having stored thereon computer executable instructions for carrying out the method of claim 35.

41. A type inference method comprising:
receiving an expression containing a variable declaration
determining whether the variable in the declaration has been examined before; and
generating an error if the variable has been previously examined.

42. The method of claim 41, further comprising
determining whether the variable and the previously examined variable are of the same type before generating an error; and
generating an error if the variable and the previously examined variable are of different types.

43. The method of claim 42, wherein a new variable indicator identifies a newly defined variable that has not been previously examined.

44. The method of claim 42, wherein the error is generated at one of a compile time and run time.

45. A computer readable medium having stored thereon computer executable instructions for carrying out the method of claim 41.
